(19) United States
(12) Patent Application Publication
(10) Pub. No.: US 2015/0166323 A1
(43) Pub. Date: Jun. 18, 2015

(54) SYSTEM, APPARATUS AND METHOD FOR HANDLING AND DISPENSING A FOOD OR BEVERAGE PRODUCT

(71) Applicants: Nin Lei TANG, Lafayette, CA (US); William Stephen TANG, Lafayette, CA (US)

(72) Inventors: Nin Lei TANG, Lafayette, CA (US); William Stephen TANG, Lafayette, CA (US)

(21) Appl. No.: 14/563,114

(22) Filed: Dec. 8, 2014

Related U.S. Application Data
(60) Provisional application No. 61/913,583, filed on Dec. 9, 2013.

(51) Int. Cl. B65D 35/28; B65D 35/56

(52) U.S. Cl. CPC B67D 7/84; B67D 7/80; B67D 7/0216

(57) ABSTRACT

A food dispensing system comprises an outer structure and a force-providing mechanism. The outer structure is adapted to enclose at least a portion of a pouch system that contains a food product, the pouch system having a squeezable element that holds the food product and a spout element for dispensing the food product. The outer structure is further adapted to allow a user to access the spout element of the pouch system, and to prevent the user from squeezing the squeezable element. The force-providing mechanism is adapted to exert a force on the squeezable element.

This application claims the benefit under 35 USC 119 of U.S. Provisional Application No. 61/913,583 filed Dec. 9, 2013, which is incorporated herein by reference.

### TECHNICAL FIELD

This specification relates to systems, apparatus and methods for handling and dispensing food and beverage products, and more particularly to systems, apparatus and methods for handling and dispensing a liquid or puree food or beverage product.

### BACKGROUND

Baby food is currently available in squeeze pouches that a baby can squeeze, similar to a tube of toothpaste. FIG. 1A illustrates a package 100 of baby food that may be commercially available and purchased, for example, at a supermarket. Package 100 comprises a pouch 110 and a cap 120; cap 120 is attached to a spout 125. As shown in FIG. 1B, package 100 may be opened by removing cap 120 from spout 125, exposing opening 130. As illustrated in FIG. 2, baby food 202 may now be squeezed out of pouch 110 through opening 130, in a manner similar to that used to squeeze toothpaste from a tube of toothpaste. After being opened, pouch 110 may be given to a baby. The baby can handle pouch 110 and obtain baby food 202 either by squeezing pouch 110 or by sucking on spout 125. Additionally, as with a tube of toothpaste, the bottom of pouch 110 may be squeezed, rolled, or folded (as shown in FIG. 2) to force baby food 202 located in the bottom of the pouch up to the top and out of opening 130.

It has been observed that current pouches of baby food, such as pouch 110 shown in FIGS. 1A-1B and FIG. 2, are disadvantageous because many babies do not have the ability to squeeze pouch 110 appropriately. For example, some babies simply lack the hand and finger strength (or coordination) needed to squeeze pouch 110 effectively. Furthermore, while a baby may learn that squeezing pouch 110 somewhere in the middle causes food to emerge from opening 130, babies often squeeze baby food from the middle and upper portions of the pouch but leave a substantial amount of baby food in the lower portions of the pouch. Few babies are capable of understanding that the pouch must be squeezed or rolled at the bottom to ensure that the baby food at the bottom of the pouch is forced out. As a result, in many instances much of the baby food in a pouch is left at the bottom of the pouch, and is wasted. This is particularly true in hot weather, or when the pouch cannot be placed quickly in a refrigerator, and the baby food remaining at the bottom of the pouch is at risk of spoiling. Another problem may occur when a baby applies excessive pressure or squeezing to the pouch, leading to an unintended expulsion of the contents of the pouch onto the baby's face, hands or clothes.

It has also been observed that many babies, while eating from a baby food pouch, such as pouch 110, may shake or inverse the pouch, causing baby food to be undesirably spilled, for example, on the baby's face or clothes, or on the ground, on furniture, etc. Again, the result of such spillage is that some of the baby food is wasted.

### SUMMARY OF THE INVENTION

In accordance with an embodiment, a food dispensing system comprises an outer structure and a force-providing mechanism. The outer structure is adapted to enclose at least a portion of a pouch system that contains a food product. The food product may be a food or a beverage, The pouch system has a squeezable element that holds the food product and a spout element for dispensing the food product. The outer structure is further adapted to allow a user holding the food dispensing system to access the spout element of the pouch system, and to prevent the user from squeezing the squeezable element. The force-providing mechanism is adapted to exert a force on the squeezable element.

In another embodiment, the squeezable element comprises a first portion proximate the spout element and a second portion opposite the spout element. The force-providing mechanism is further adapted to exert a force on the second portion of the squeezable element.

In another embodiment, the spout element comprises a straw.

In one embodiment, the outer structure comprises a foldable case having first and second parts substantially of a same size, the first and second parts being connected by a joint.

In another embodiment, the first and second halves are adapted to be folded together and closed to form a case capable of enclosing the squeezable element.

In another embodiment, the first and second halves comprise respectively first and second indentations, the first and second indentations collectively form an opening when the first and second halves are folded together, and the spout element protrudes from the opening.

In another embodiment, the force-providing mechanism comprises a spring.

In another embodiment, the food dispensing system also includes a valve, which may be a one-way valve or a restrictive flow valve, for example, adapted to cover the spout element. The valve may be a silicon nipple or a plastic nipple, for example.

In accordance with another embodiment, a system for dispensing a food product is provided. The system includes first and second parts connected by a joint, the first part having a first edge having a first indentation, the second part having a second edge having a second indentation, and a force-providing mechanism disposed on of the first and second parts. The first and second parts are adapted to be alternately in an open state in which the first and second edges are not adjacent and in a closed state in which the first and second edges are adjacent. The first and second parts form a substantially hollow case having an opening when the first and second parts in in the closed state. The hollow case is adapted to hold a squeezable food product pouch, the squeezable food product pouch having a spout element for dispensing a food product. The force-providing mechanism is adapted to exert a force on the squeezable food product pouch, the force being sufficient to cause the food product to be dispensed from the spout element.

These and other advantages of the present disclosure will be apparent to those of ordinary skill in the art by reference to the following Detailed Description and the accompanying drawings.

### BRIEF DESCRIPTION OF THE DRAWINGS

FIG. 1A illustrates a package of baby food that may be commercially available and purchased;

FIG. 1B shows the baby food package of FIG. 1A with the top removed from the pouch;

FIG. 2 shows the pouch of FIG. 1A after a quantity of baby food has been squeezed from the pouch;

FIG. 3A illustrates a foldable case in accordance with an embodiment;

FIG. 3B shows a side view of the foldable case of FIG. 3A;

FIG. 3C shows another side view of the foldable case of FIG. 3A;

FIG. 4A shows a baby food pouch placed in a foldable case in accordance with an embodiment;

FIG. 4B shows a side view of the foldable case and baby food pouch shown in FIG. 4A;

FIG. 4C shows a side view of the foldable case shown in FIG. 4A in a closed state, enclosing a baby food pouch;

FIG. 4D is a schematic illustration of a baby food pouch enclosed in a foldable case;

FIG. 4E shows a baby food pouch enclosed in a foldable case;

FIG. 5A illustrates a food product dispensing system in accordance with an embodiment;

FIGS. 5B-5C illustrate the action of a force-providing mechanism within a foldable case in accordance with an embodiment;

FIG. 6A shows a foldable case with a force-providing mechanism in accordance with another embodiment;

FIG. 6B shows a foldable case with a force-providing mechanism in accordance with another embodiment;

FIG. 6C shows a foldable case with a force-providing mechanism in accordance with another embodiment;

FIG. 6D shows a foldable case with a force-providing mechanism in accordance with another embodiment;

FIG. 7A shows a baby food pouch and a plastic nipple;

FIG. 7B shows a baby food pouch and a plastic nipple placed in a foldable case in accordance with an embodiment;

FIG. 7C shows a food product dispensing system in accordance with an embodiment;

FIG. 8 shows a baby using a food product dispensing system in accordance with an embodiment.

FIG. 9 shows foldable case with insulation; and

FIG. 10 shows foldable case with a second pocket for a warming or cooling packet.

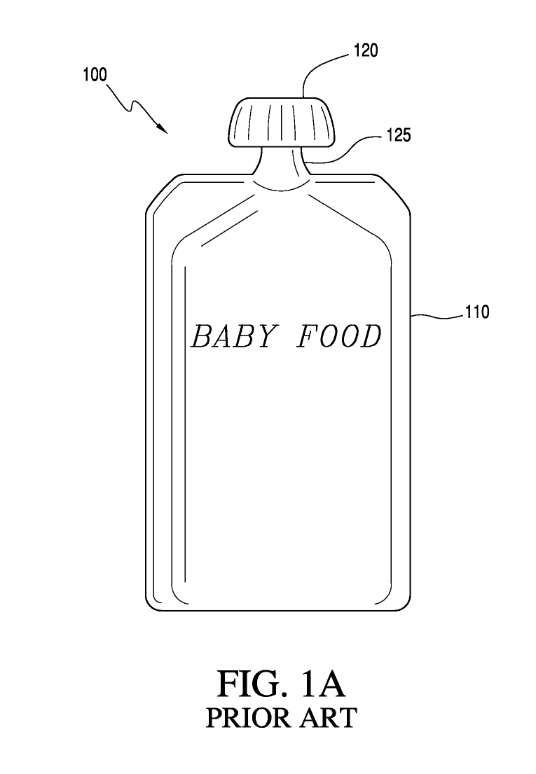

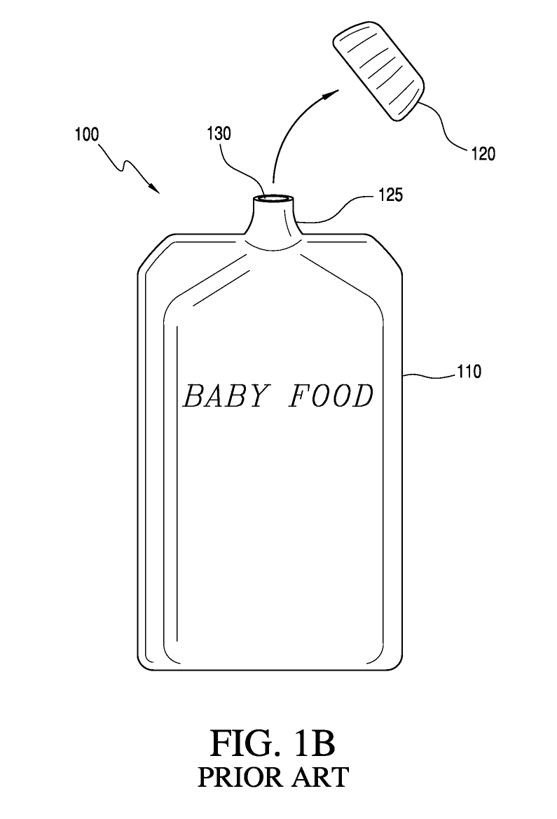

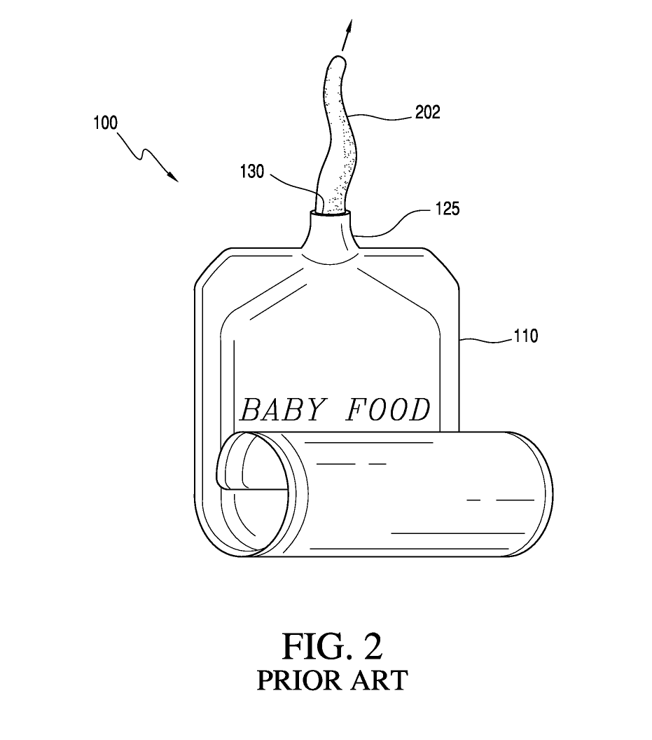

### DETAILED DESCRIPTION

In accordance with an embodiment, a food product dispensing system comprises an outer structure and a force-providing mechanism. As used herein, the term food product may encompass any type of food or beverage intended for infants, children, or adults. The outer structure is adapted to enclose at least a portion of a pouch system that contains a food product, the pouch system having a squeezable element that holds the food product and a spout element for dispensing the food product. For example, the pouch system may be a squeezable pouch containing baby food, liquid drinks, or purees intended for adults. The spout element may comprise a straw. The outer structure is further adapted to allow a user (e.g., a baby) who is holding the food product dispensing system to access the spout element of the pouch system, and to prevent the user from squeezing the squeezable element. The force-providing mechanism is adapted to exert a force on the squeezable element. The food product dispensing system may also include a valve to control the dispensing of the food product from the spout element. The valve may be a one-way valve or a restrictive flow valve, for example.

In one embodiment, the squeezable element comprises a first portion proximate the spout element and a second portion opposite the spout element. The force-providing mechanism is further adapted to exert a force on the second portion of the squeezable element.

In another embodiment, the spout element comprises a straw.

Systems, apparatus, and methods are described herein for use with a squeezable pouch containing baby food. However, systems, apparatus and methods described herein may be used with any squeezable container holding any type of food or beverage product, such as yoghurt, applesauce, juice, water, milk, or any type processed food product in the form of a paste, liquid, etc.

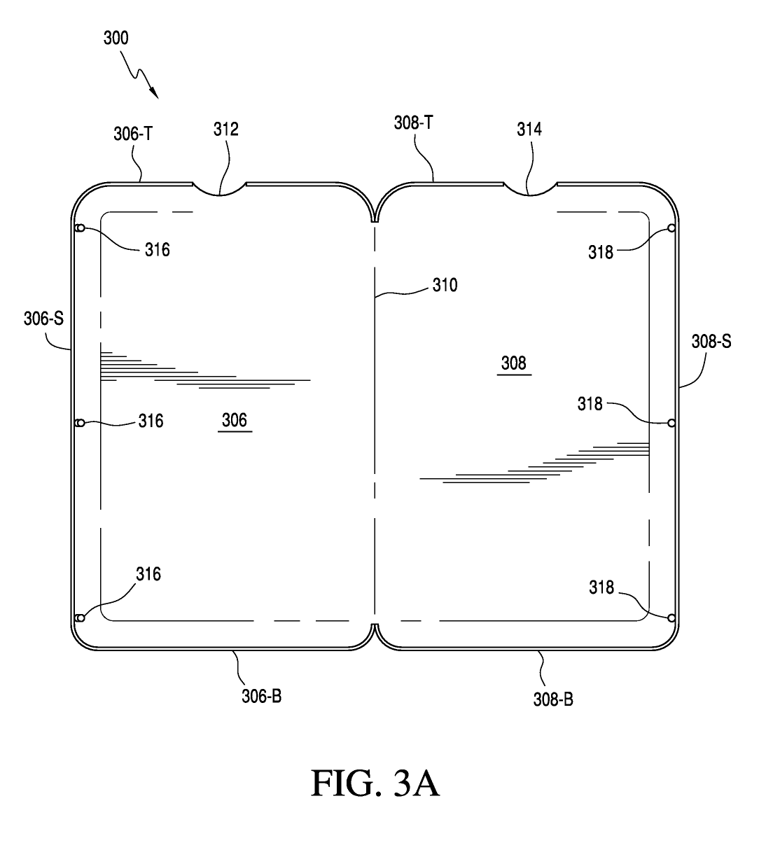

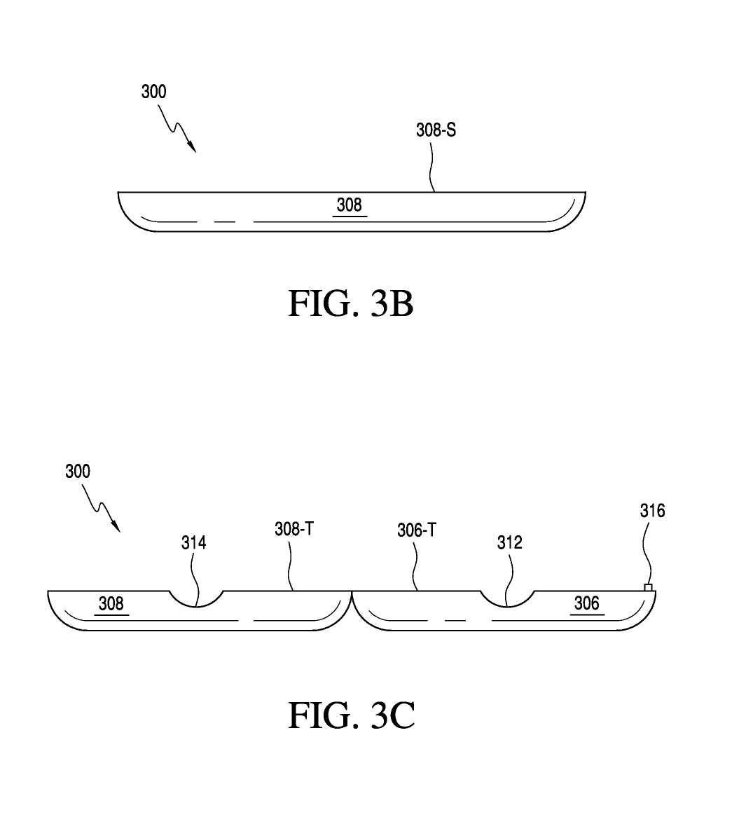

In accordance with an embodiment, a foldable case for a baby food pouch is provided. FIG. 3A illustrates a foldable case 300 in accordance with an embodiment. Foldable case 300 may be alternately in an open state and in a closed state. In FIG. 3A, foldable case 300 is shown in an unfolded, open state. As shown in FIG. 3A, foldable case 300 comprises a two halves—a half 306 and a half 308. Half 306 has a top edge 306-T, a side edge 306-S, and a bottom edge 306-B. Similarly, half 308 has a top edge 308-T, a side edge 308-S, and a bottom edge 308-B. Halves 306 and 308 are connected by a joint 310. In the illustrative embodiment, joint 310 is a crease; however, joint 310 may be any type of joint that joins halves 306, 308 and allows halves 306, 308 to open and close. Accordingly, the two halves 306, 308 may be folded along joint 310 and brought together to close and to form a hollow case. In one embodiment, two halves 306, 308 may be folded along joint 310 and brought together to close and form a hollow clamshell-type case.

In the illustrative embodiment, foldable case 300 includes several protrusions 316 along side edge 306-S of half 306, and corresponding holes 318 along side edge 308-S of half 308. When the two halves 306, 308 are folded together, each protrusion 316 fits tightly into a corresponding hole 318, holding case 300 in a closed state. Other mechanisms may be used to close case 300, including, without limitation, a latch, a hook, etc.

The structure of foldable case 300 may comprise any suitable material sufficiently hard to prevent a user (e.g., a baby) from squeezing a baby food pouch that may be held within the case. In particular, when a baby squeezes on outer surface of case 300, the structure of case 300 does not compress sufficiently to exert substantial pressure on the squeezable pouch held inside. For example, in one embodiment, foldable case 300 comprises a hard plastic having sufficient stiffness to prevent a user (e.g., a baby) from squeezing a baby food pouch held within the case. In other embodiments, case 300 may comprise another material such as a soft plastic, leather, etc. Case 300 may also comprise an outer surface made of a soft, pliable material that allows a baby to squeeze the outer surface of case 300, thereby exercising his or her fingers, without compressing the structure of the case.

While in the illustrative embodiment, foldable case 300 comprises two halves of substantially the same size and shape, in other embodiments a foldable case may comprise two (or more) parts of different sizes and shapes, adapted to be alternately in an open state and in a closed state and to enclose at least a portion of a squeezable pouch.

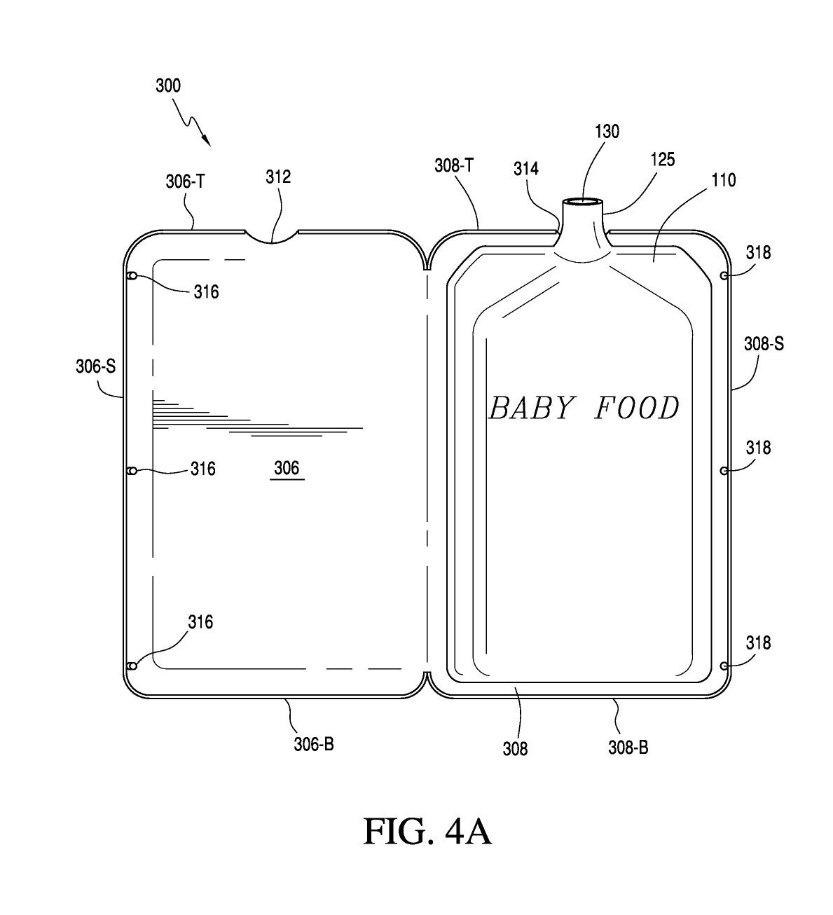

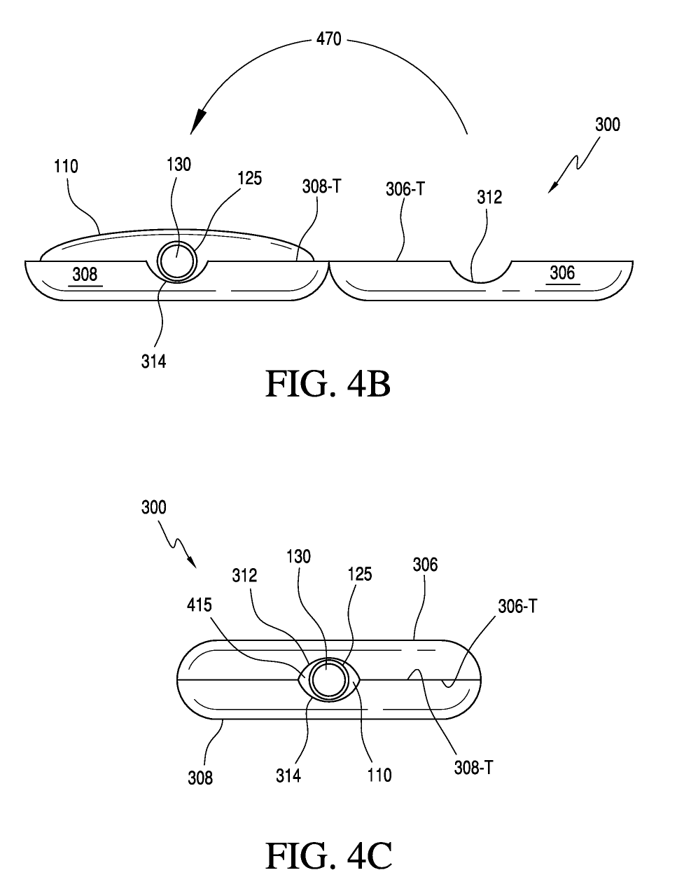

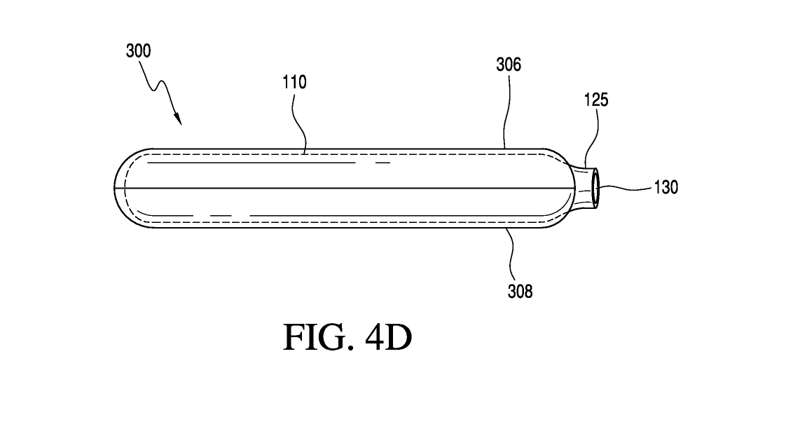

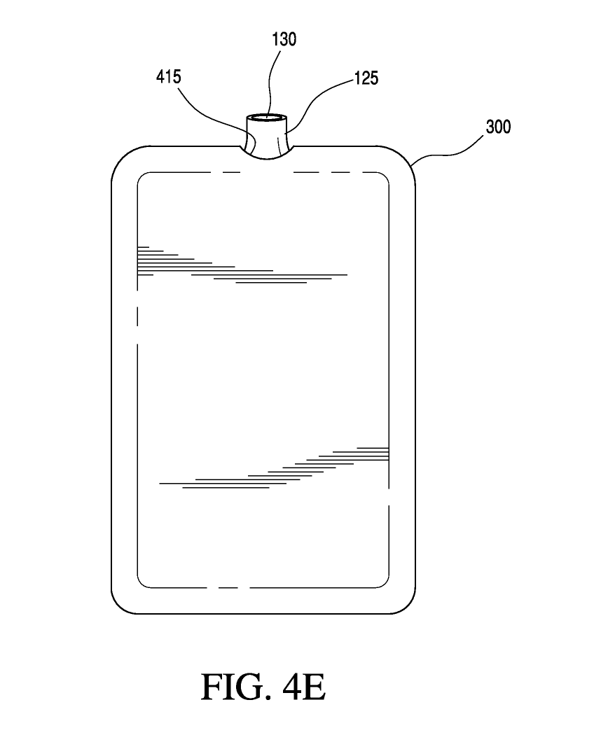

In the illustrative embodiment, foldable case 300 also includes two curved indentations 312, 314 located in top edges 306-T, 308-T, respectively. When case 300 is closed, top edges 306-T, 308-T come together and are adjacent, and indentations 312, 314 align to create an opening in a top side of the closed case (as shown in FIG. 4C).

FIG. 3B shows a side view of foldable case 300, in an open state, in accordance with the embodiment of FIG. 3A. In particular, FIG. 3B shows a side view of side edge 308-S of half 308.

FIG. 3C shows a side view of foldable case 300, in an open state, in accordance with the embodiment of FIG. 3A. In particular, FIG. 3C shows a side view of top edges 306-T, 308-T of case 300. Thus, indentations 312, 314, are visible. As shown in FIG. 3C, when case 300 is in an open state, top edges 306-T, 308-T are not adjacent.

In accordance with an embodiment illustrated in FIGS. 4A-4E, a squeezable baby food pouch may be placed into foldable case 300, and case 300 is closed so that only the spout of the pouch protrudes from case 300. FIG. 4A shows foldable case 300 in an open state in accordance with an embodiment. Squeezable baby food pouch 110 is placed in half 308 of foldable case 300. Spout 125 is aligned with indentation 314 and protrudes from case 300 beyond indentation 314.

FIG. 4B shows a side view of case 300 and baby food pouch 110 in accordance with the embodiment of FIG. 4A. Top edges 306-T, 308-T are visible. Baby food pouch 110 is disposed in half 308 of case 300. Spout 125 and opening 130 are visible.

In accordance with an embodiment, half 306 of case 300 may be folded over, on top of half 308, as indicated by arrow 470 in FIG. 4B, to close case 300. As case 300 is closed, the various edges of halves 306, 308 are brought together, closing the case. FIG. 4C shows a side view of case 300 in a closed state, in accordance with an embodiment, showing baby food pouch 110 enclosed in case 300. As shown in FIG. 4C, top edges 306-T, 308-T are adjacent. Indentations 312, 314 collectively create an opening 415. Opening 415 may be round, square or any other shape. Spout 125 and opening 130 of pouch 110 protrude from opening 415.

FIG. 4D is a schematic illustration of baby food pouch 110 enclosed in case 300 in accordance with the embodiment of FIG. 4C. The placement of baby food pouch 110 within case 300 is indicated by a dotted line. Spout 125 and opening 130 protrude from case 300.

FIG. 4E shows case 300 in a closed state holding baby food pouch 110 in accordance with the embodiment of FIG. 4C. Spout 125 protrudes from opening 415. Preferably, indentations 312, 314 form a tight grip on spout 125 to prevent pouch 110 falling inward into closed case 300. Conventionally, spout 125 has ridges or rings which protrude and allow indentations 312 and 314 to grip spout 125 and hold spout 125 in place.

The foldable case 300 shown in FIGS. 3A-3C and in FIGS. 4A-4E may be handled by a baby, and the baby may obtain baby food by, for example, sucking on spout 125. Advantageously, the stiffness of foldable case 300 may prevent the baby from squeezing the pouch 110 and spilling the baby food on clothing or furniture.

Because a portion of the baby food in a pouch may remain at the bottom of the pouch if not forced out, there is a need for a mechanism to force baby food out of the bottom portion of a baby food pouch. In accordance with another embodiment, a food product dispensing system comprising a foldable case adapted to hold a squeezable food product pouch, and a force-providing mechanism that exerts a force on the pouch, is provided.

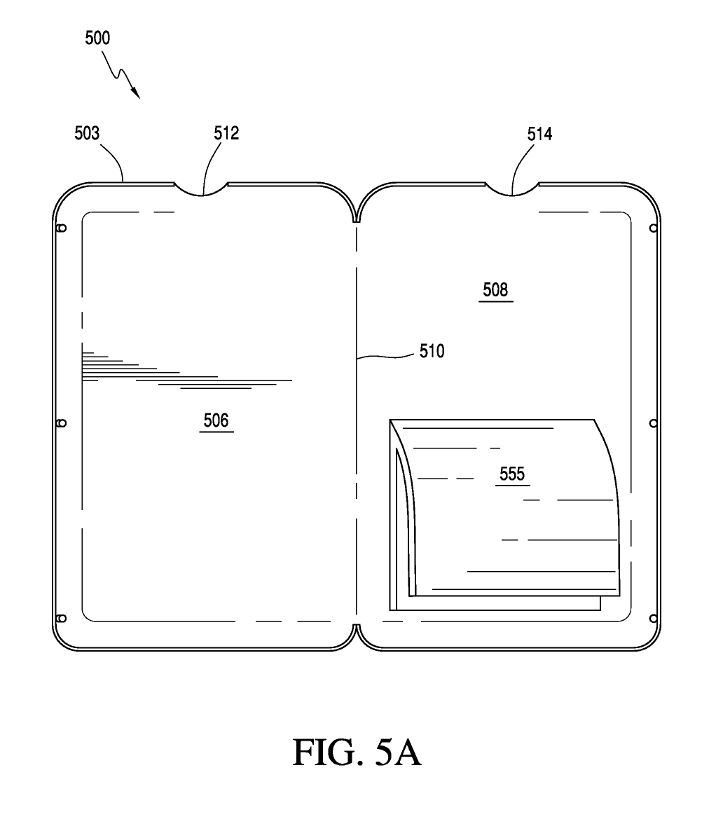

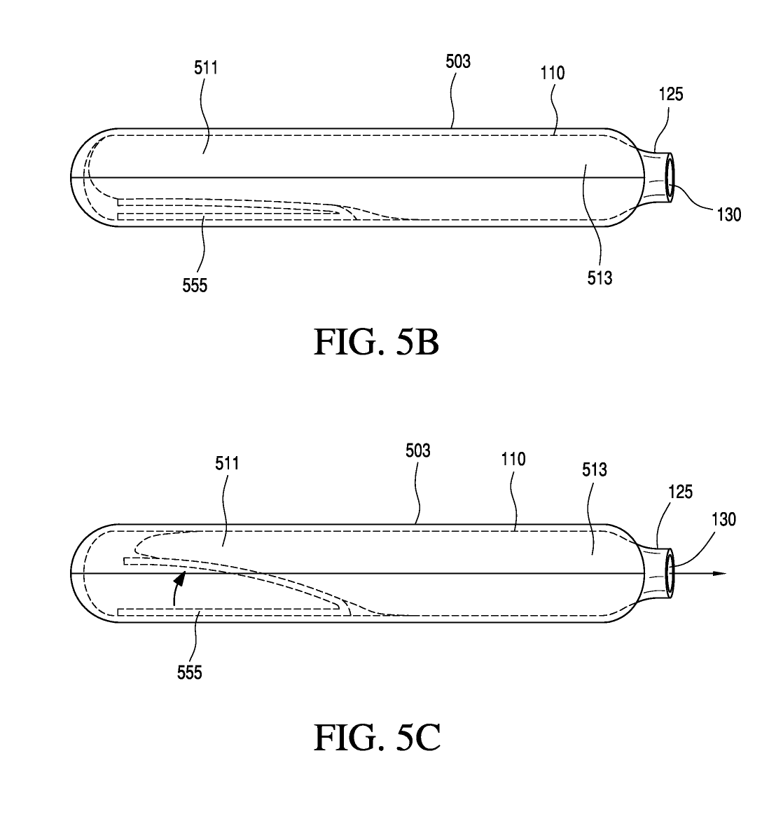

FIG. 5A shows a food product dispensing system 500 in accordance with an embodiment. Food product dispensing system 500 comprises a foldable case 503 having two halves 506, 508, separated by a joint 510 (similar to foldable case 300 discussed above). Case 503 also includes a force-providing mechanism 555. Force-providing mechanism 555 exerts a force that forces baby food out of the baby food pouch. Advantageously, force-providing mechanism 555 may be disposed in the lower half of half 508 of case 503, opposite indentation 514, forcing food out of the bottom portion of the baby food pouch. In the illustrative embodiment of FIG. 5A, force-providing mechanism 555 is a spring. For example, force-providing mechanism may be a leaf spring.

FIGS. 5B-5C illustrate the action of force-providing mechanism 555 within case 503 in accordance with an embodiment. When baby food pouch 110 is enclosed in case 503, in a manner similar to that shown in FIGS. 4A-4E, force-providing mechanism 555 is initially compressed in order to accommodate pouch 110, as shown in FIG. 5B. For example, a user may press down on force-providing mechanism 555 in order to create space for pouch 110 within case 503, and then place pouch 110 in position within case 503, and then close the case.

After case 503 is closed, force-providing mechanism 555 exerts a force on a bottom portion 511 of pouch 110, as illustrated in FIG. 5C. As referred to herein, pouch 110 comprises a top portion 513 proximate spout 125, and a bottom portion 511 proximate an end of the pouch that is opposite spout 125.

As baby food is removed from opening 130 of pouch 110 (e.g., as a baby sucks the baby food out of the pouch), force-providing mechanism 555 presses on the bottom portion 511 of pouch 110, causing any baby food in the bottom portion 511 of the pouch to migrate toward the middle of pouch 110 and/or toward top portion 513 of the pouch. Furthermore, force-providing mechanism 555 expands and occupies some or all of the volume vacated by the baby food that leaves the bottom portion 511; this action ensures that little or no baby food will migrate back to bottom portion 511 of pouch 110. Consequently, the bottom portion 511 of pouch 110 is gradually emptied of its contents. Advantageously, because baby food located in the middle of pouch 110 and/or in top portion 513 of pouch 110 is closer to opening 130, a baby can more easily suck such food out of pouch 110. A baby can thus obtain an increased amount of baby food from the pouch, and as a result, a smaller amount of food remains in the pouch (and thus less baby food is potentially wasted) after feeding.

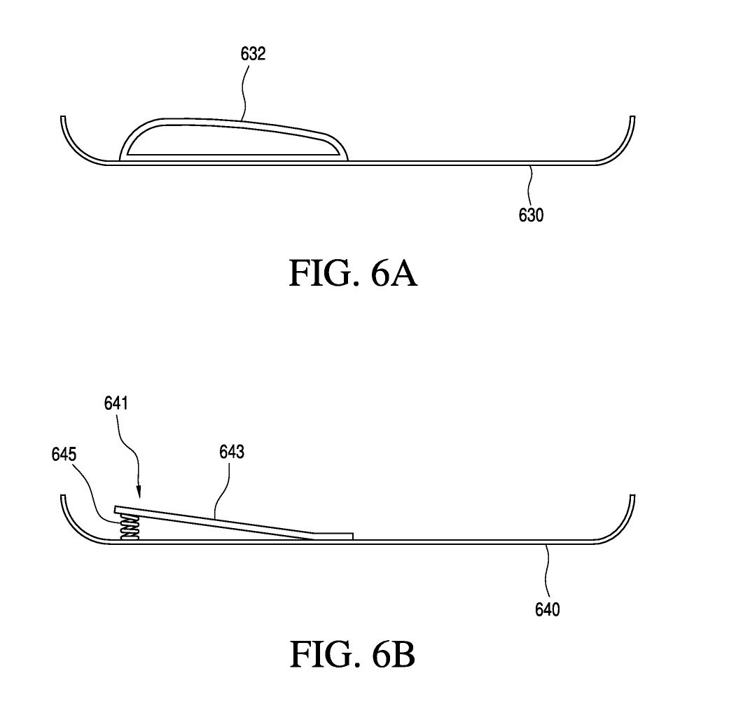

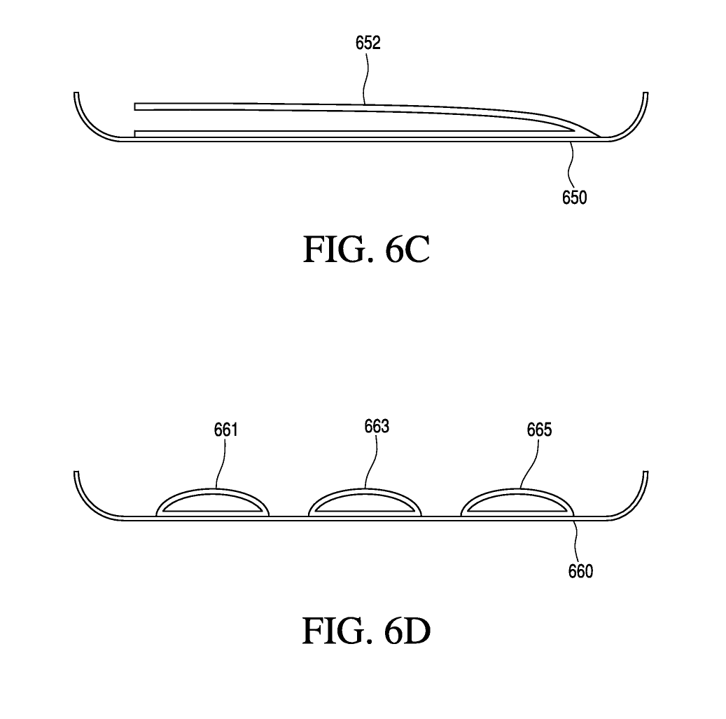

FIG. 6A shows a side view of a foldable case 630 with a force-providing mechanism 632 in accordance with another embodiment. In this embodiment, force-providing mechanism 632 is a leaf spring having a curved but continuous shape. When compressed, spring 632 exerts a force until it returns to its original shape. For example, spring 632 may exert a force on any baby food pouch enclosed in case 630.

FIG. 6B shows a side view of a foldable case 640 with a force-providing mechanism 641 in accordance with another embodiment. In this embodiment, force-providing mechanism 641 comprises a movable actuator 643 connected to a spring 645. When compressed, spring 645 exerts a force on actuator 643, and actuator 643 in turn exerts a force on any baby food pouch enclosed in case 640.

In other embodiments, a foldable case may include one or more springs adapted to exert a force on an entire squeezable pouch, including top, middle and bottom portions, for example. This feature is illustrated by FIGS. 6C and 6D.

FIG. 6C shows a side view of a foldable case 650 with a force-providing mechanism 652 in accordance with another embodiment. In this embodiment, force-providing mechanism 652 is a spring that extends substantially the entire length of case 650. When compressed, spring 652 exerts a force on both the top and bottom portions of any squeezable pouch enclosed in case 650. For example, spring 652 may exert a force on the top and bottom portions of any baby food pouch enclosed in case 650.

FIG. 6D shows a side view of a foldable case 660 with a plurality of force-providing mechanisms 661, 663, 665 in accordance with another embodiment. In this embodiment, each force-providing mechanism 661, 663, 665 is a leaf spring having a curved but continuous shape. When compressed, springs 661, 663, 665 exert pressure on the top, middle and bottom portions of any squeezable pouch enclosed in case 660. For example, springs 661, 663, 665 may exert pressure on any baby food pouch enclosed in case 660.

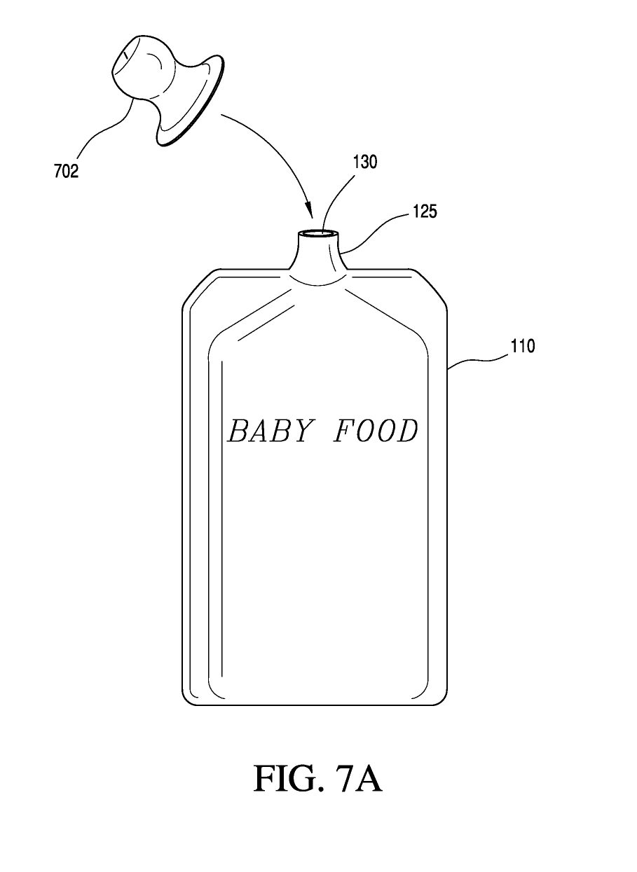

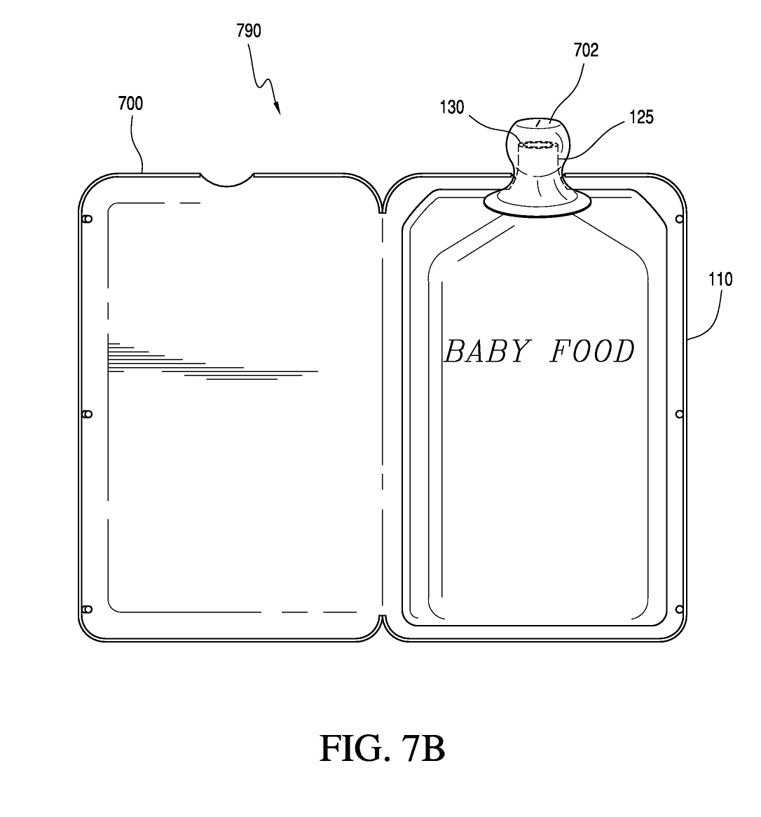

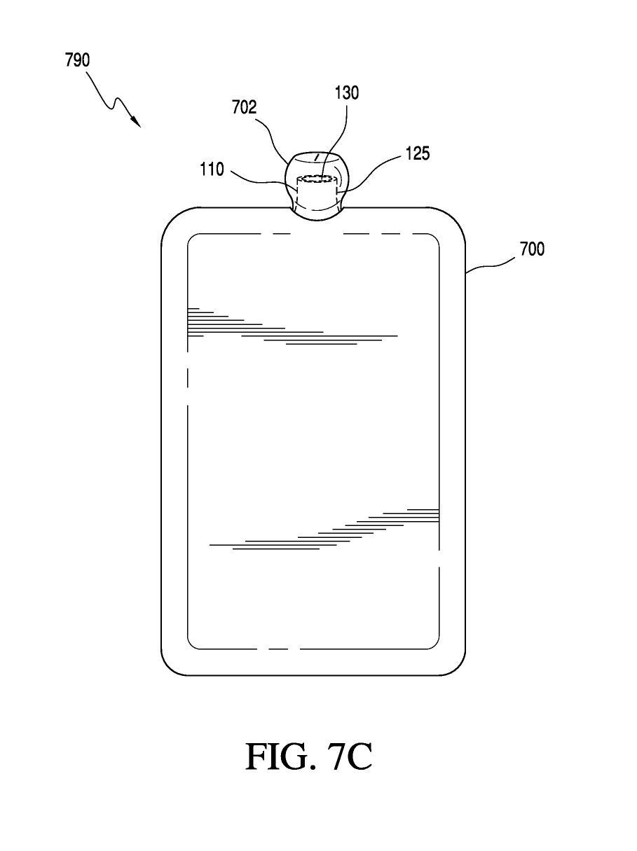

In accordance with another embodiment, a food product dispensing system is provided. The food product dispensing system includes a valve which is placed over the spout and opening of a baby food pouch. The valve may be a one-way valve or a restrictive flow valve, such as a silicon or plastic nipple. For example. The pouch and valve are in turn placed into and enclosed within a foldable case. FIG. 7A shows baby food pouch 110 and a plastic nipple 702. Nipple 702 is placed over spout 125 and opening 130, and then pouch 110 and nipple 702 are enclosed in a foldable case. FIG. 7B shows a food product dispensing system 790 comprising a pouch 110 and a plastic or silicon nipple 702 placed in a foldable case 700 in accordance with an embodiment. Case 700 may be a foldable case such as any of those described above and shown in FIGS. 3A, 5A, etc. Case 700 may comprise a force-providing mechanism similar to those described above. Case 700 may be closed in a manner similar to that described above.

FIG. 7C shows food product dispensing system 790 in a closed state, in accordance with the embodiment of FIG. 7B. Food product dispensing system 790 comprises foldable case 700, baby food pouch 110 (partially enclosed in case 700), and nipple 702 (also partially enclosed within case 700). Spout 125 of pouch 110 projects from case 700; however, spout 125 and opening 130 are covered by nipple 702. Advantageously, a baby may use system 790 to obtain baby food, for example, by sucking on nipple 702; however, because nipple 702 prevents baby food from being dispensed unless the baby sucks on the nipple, baby food cannot be inadvertently spilled by the baby. For example, when the baby shakes or inverts case 700, nipple 702 prevents or reduces any spillage of baby food.

The features shown in FIGS. 7A-7C are not to be construed as limiting. For example, while a plastic or silicon nipple is used in the embodiment of FIGS. 7A-7C, any one-way valve or restrictive flow valve may be used.

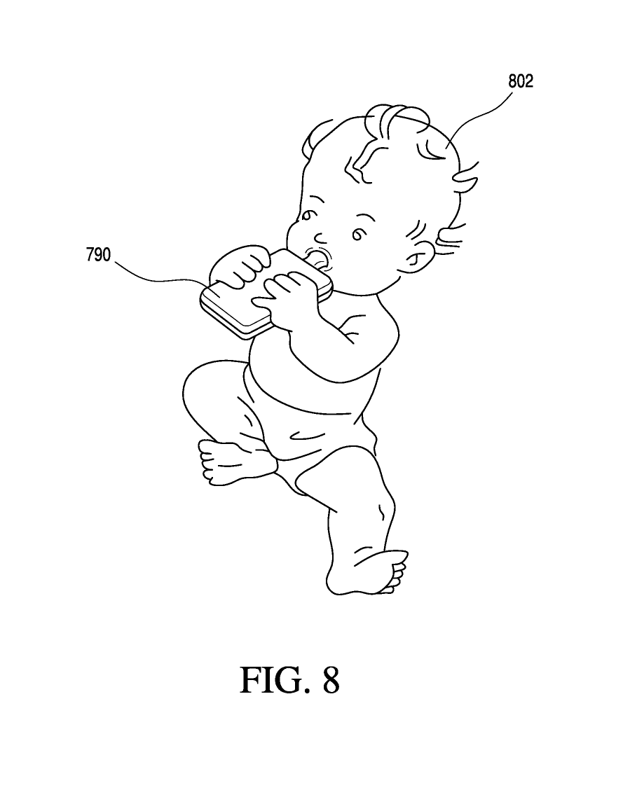

FIG. 8 shows a baby 802 using food product dispensing system 790 in accordance with an embodiment. Baby 802 can obtain baby food by sucking on nipple 702.

In order to load case 300 with pouch 110, pouch 110 is placed into open case 300, as shown in FIG. 4B with cap 120 still on pouch 110. Once case 300 has been closed around pouch 110 and baby 802 is ready to eat, then cap 120 is removed from pouch 110.

If baby 802 is finished with eating and food remains in pouch 110, then cap 120 can be placed back on spout 125. Pouch 110 with cap 120 can remain in closed case 300 until baby 802 is ready to eat again.

Case 300 is suitably washable and reusable while pouch 110 is thrown away and not reused. However, there are commercial pouches which are reusable. Specifically, there are commercial pouches which the user fills themselves with baby food. All such pouches are usable in the present invention.

Suitably, the outside of case 300 can have a color or picture that is appealing to the baby or young toddler. For example, the pouch can have a picture of a teddy bear or cat thereon to provide visual appeal to the baby. Also, the case can be formed of a clear plastic to allow the baby food pouch to show through.

The shape of case 300 can also be varied for ergonomics of the baby or young toddler to make it easier to hold.

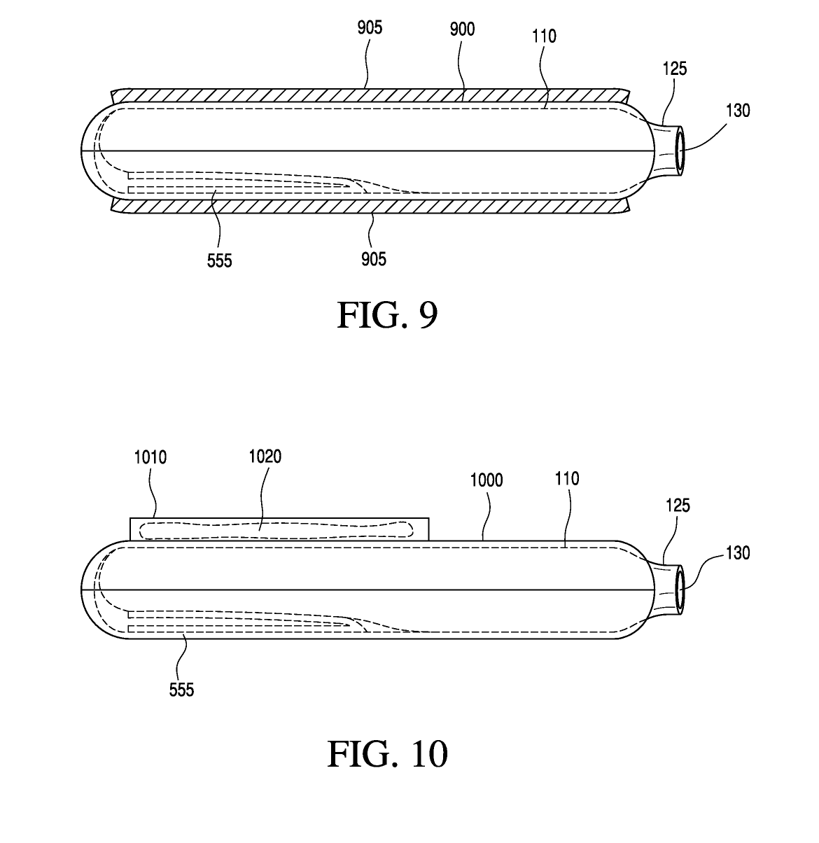

Further, as shown in FIG. 9, case 900 can be insulated to maintain the squeeze pouch contents at a cool or warm temperature. Suitably, the squeeze pouch is heated or cooled and the insulation maintains the temperature. FIG. 9 shows case 900 has insulation 905 on the outside. Insulation 905 can be either a glove or sleeve that fits over case 900 or built onto case 900.

Also, the case can have a second pocket for holding ice or a cooling packet to help cool the squeeze pouch. The second pocket can also hold a hand warming packet or pocket warming packet to warm or maintain the temperature of the squeeze pouch. Such cooling packets and heating packets are commercially available. Such a system allows the parent to heat or cool the squeeze pouch while on the go. FIG. 10 illustrates case 1000 with second pocket 1010 and heating or cooling packet 2010 therein.

Although the squeeze pouches are marketed for baby food, there is an increasing older generation, where liquid or puree food is desired. For the older consumer, the case in accordance with the present invention can be used with a squeezable pouch.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A food product dispensing system comprising:
an outer structure adapted to:
enclose at least a portion of a pouch system that contains a food product, the pouch system having a squeezable element that holds the food product and a spout element for dispensing the food product;
allow a user holding the food dispensing system to access the spout element of the pouch system; and
prevent the user from squeezing the squeezable element; and
a force-providing mechanism adapted to exert a force on the squeezable element.

2. The food product dispensing system of claim 1, wherein the food product is one of a food and a beverage.

3. The food product dispensing system of claim 1, wherein:
the squeezable element comprises a first portion proximate the spout element and a second portion opposite the spout element; and
the force-providing mechanism is further adapted to exert a force on the second portion of the squeezable element.

4. The food product dispensing system of claim 1, wherein the spout element comprises a straw.

5. The food product dispensing system of claim 1, wherein the outer structure comprises a foldable case having first and second halves substantially of a same size, the first and second halves being connected by a joint.

6. The food product dispensing system of claim 5, wherein the first and second halves are adapted to be folded together and closed to form a case capable of enclosing the squeezable element.

7. The food product dispensing system of claim 6, wherein the first and second halves comprise respectively first and second indentations,
wherein the first and second indentations collectively form an opening when the first and second halves are folded together,
wherein the spout element protrudes from the opening.

8. The food product dispensing system of claim 1, wherein the force-providing mechanism comprises a spring.

9. The food product dispensing system of claim 1, further comprising:
a valve adapted to cover the spout element, the valve being one of a one-way valve and a restrictive flow valve.

10. The food product dispensing system of claim 9, wherein the valve is one of a silicon nipple and a plastic nipple.

11. The food product dispensing system of claim 1, wherein the first and second halves are insulated.

12. The food product dispensing system of claim 1, wherein one of the first and second halves has a second pocket for a cooling packet or a heating packet.

13. The food product dispensing system of claim 1, wherein one of the first and second halves comprises one of a transparent material and a transparent window to view an interior of the system from an exterior of the system.

14. The food product dispensing system of claim 1, wherein one of the first and second halves has a hole adapted to accommodate a string adapted to tie down to secure the system to a fixed object.

15. The food product dispensing system of claim 1, wherein one of the first and second halves has dedicated non-slip areas for holding or gripping.

16. The food product dispensing system of claim 1, wherein one of the first and second halves includes an indentation adapted to hold a loose baby food cap.

17. A system for dispensing baby food, the system comprising:
first and second parts connected by a joint, the first part having a first edge having a first indentation, the second part having a second edge having a second indentation; and
a force-providing mechanism disposed on one of the first and second parts;
wherein the first and second parts are adapted to be alternately in an open state in which the first and second edges are not adjacent and in a closed state in which the first and second edges are adjacent;
wherein the first and second parts form a substantially hollow case having an opening, when the first and second parts in in the closed state;
wherein the hollow case is adapted to hold a squeezable food pouch, the squeezable food pouch having a spout element for dispensing a food product;
wherein the force-providing mechanism is adapted to exert a force on the squeezable food pouch, the force being sufficient to cause at least a portion of the food product to migrate from a first portion of the squeezable food pouch opposite the spout element to a second portion of the squeezable pouch proximate the spout element.

18. The system of claim 17, wherein the first and second parts are two halves of a clamshell case.

19. The system of claim 17, wherein the force-providing mechanism comprises a spring.

20. The system of claim 17, further comprising:
a valve adapted to cover the spout element.

21. The system of claim 20, wherein the valve is one of a silicon nipple and a plastic nipple.
